(19) United States
(12) Patent Application Publication
(10) Pub. No.: US 2004/0085559 A1
(43) Pub. Date: May 6, 2004

(54) Apparatus for printing using non-overlapping graphic objects

(75) Inventor: Alexander Vincent Danilo, Killarney Heights (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/662,319

(22) Filed: Sep. 16, 2003

(30) Foreign Application Priority Data
Sep. 25, 2002 (AU) 2002951651

(51) Int. Cl. B41F 1/00; G06F 15/00

(52) U.S. Cl. 358/1.12; 358/1.18

(57) ABSTRACT

A method of printing an image is disclosed. The method comprises generating at a host (102), from an image (600) to be printed, a display list representation (312) of a visually equivalent image (1100) comprising non-overlapping graphic objects (614′, 616′); and scan-line rendering (510), using the display list representation (312), the visually equivalent image (1100) at a printer (108) communicating with the host (102), without performing overlap detection at the printer (108).

### CROSS-REFERENCE TO RELATED PATENT APPLICATION

This application claims the right of priority under 35 U.S.C. § 119 based on Australian Patent Application No. 2002951651, filed 25 Sep. 2002, which is incorporated by reference herein in its entirety as if fully set forth herein.

### COPYRIGHT NOTICE

This patent specification contains material that is subject to copyright protection. The copyright owner has no objection to the reproduction of this patent specification or related materials from associated patent office files for the purposes of review, but otherwise reserves all copyright whatsoever.

### TECHNICAL FIELD OF THE INVENTION

The present invention relates generally to computer-based printing systems and, in particular, to inexpensive printing systems for high speed printing.

### BACKGROUND ART

FIG. 1 shows a functional block diagram for a system 100 for Personal Computer (PC) based printing. A host machine 102 having a printing pre-processor 104 communicates over a connection 106 with a communication bus 114. A printer 108 having an embedded printing processor 110 communicates over a connection 112 with the communication bus 114.

FIG. 2 shows a flow diagram of a generic process 300 by which the system of FIG. 1 performs printing. A first step 302 parses input data in Page Description Language (PDL) after which a step 306 generates object representations therefrom. A subsequent step 310 scanline-processes the objects after which a step 314 renders the scanline processed data to sequential pixels, for printing by a final print step 318. The steps 302 to 310 are typically implemented, as indicated by an arrow 322, in the host machine 102 by the printing pre-processor 104, whereas the steps 314 to 318 are generally performed in the printer 108 by the printing processor 110 and a print engine 222 (see FIG. 3).

In the printer system 100, the communication bus 114 typically uses low-speed serial protocols such as the universal serial bus (USB), or alternately uses parallel protocols such as IEEE 1284.

In low cost printers the printing processor 110 needs to be a low cost device in order to keep the cost of the printer 108 to a minimum. The consequent hardware limitations of the processor 110 lead to an approach where a pre-rendered bitmap is generated in the host machine pre-processor 104 in the step 310. This is referred to as the bitmap approach. The pre-rendered bitmap is then sent to the processor 110 in the printer 108 for rendering to sequential pixels in the step 314. An exemplary pre-rendered compressed bitmap for an A4 6-ink bubble jet page consumes typically 35 to 40 megabytes of data, which requires 40 to 50 seconds of transmission using the USB protocol. This is a significant delay, however users of inexpensive printers are generally satisfied with the cost/speed trade off.

In more expensive printers, the burden of computation can be shifted from the host-processor 104 to the printer processor 110, allowing elimination of the data transmission bottleneck over the bus 114, and thereby speeding up printing of the print job. This is achieved by sending the page data over the bus 114 using a more efficient data representation. In one such arrangement, the scanline-processing step 310 generates a “display list” representation of the data to be printed, this representation consuming less data than the pre-rendered bit-map representation. This is referred to as the display list approach. The display list approach requires the rendering step 314 to render the display list to a bitmap for printing in the print step 318. In some cases, the display list may be interpreted to provide pixels for direct printing without writing pixels to a bit-map.

Display lists represent graphic objects by edges, which may be straight line vectors, quadratic line segments etc. These edges are stored in the display list (also referred to as an edge list) by edge records that may include, for example, the following four elements:

(i) a current scan line intersection co-ordinate (referred to as the X co-ordinate),

(ii) a count (referred to herein as NY) of how many scan lines a current segment of this edge will last for (in some embodiments this may be represented as a Y limit),

(iii) a value to be added to the X co-ordinate of this edge record after each scan line (referred to here as the DX), and

(iv) a direction (DIR) flag which indicates whether the edge crosses scan lines in an upward (+) or a downward (−) manner.

Display list techniques use the known order of rendering (as determined by the pixel position X of an edge on a particular scanline Y) to determine on a pixel by pixel basis how an object should finally be painted onto the bitmap for printing. In the exemplary case considered here, objects being printed are opaque. In this case, if a number of graphic objects overlap, the object which is painted last will be fully visible, while objects painted earlier will be obscured. This mode of operation is commonly referred to as the “painter's algorithm” since all objects are painted but only the topmost object is finally made visible. If many coincident objects exist on a page, an individual pixel may thus be re-written a number of times to the bit memory, repetitively consuming memory bandwidth and processing cycle time, and generating data which is ultimately discarded.

In a variation of the display list approach, display list data is stored for all objects on a page, however each object is tagged with a layer number, thus enabling the relative viewing position of the object, with reference to other objects on the page, to be determined. This technique, referred to as the display list variation approach, is implemented by adding an additional (fifth) element to the edge record in the display list as follows:

(v) one or more priority numbers (P), (which represent the layer position of the object whose edge is being considered relative to the layer position of other page objects).

In this case, during rendering by the step 314, the printing processor 110 scans horizontally across a page evaluating, at each pixel position, which object is on top before outputting a pixel value for the pixel position. The rendering step 314 dynamically generates the pixel by examining all active objects at the particular pixel position, and writing only the pixel for the object that is topmost on the page. Accordingly, the output pixel at each pixel position is only output once.

In order to perform both the display list approach, and the display list variation approach, a list of active edges must be maintained by the printing processor 110 for objects on a per-scan line basis. Only those objects having an edge that falls on the scanline being considered are examined when deciding on the object to be painted at a particular pixel position.

In summary, the conventional bitmap approach places a high processing burden on the host processor 104, thereby reducing the processing burden on the printer processor 110 and enabling manufacture of relatively inexpensive printers as a result. The bitmap approach typically suffers, however, from a transmission bottleneck due to the limited bandwidth available in the communication bus 114 and consequently from poor printing throughput. The display list approaches place a significantly greater burden of computation on the printing processor 110, raising the cost of the printer, but generally providing better performance in printing throughput.

### SUMMARY OF THE INVENTION

It is an object of the present invention to substantially overcome, or at least ameliorate, one or more disadvantages of existing arrangements.

Disclosed are arrangements which seek to address the above problems by generating at a host, from an image to be printed, a visually equivalent image comprising non-overlapping graphic objects. This visually equivalent image can be scan-line rendered at a printer communicating with the host, without the need to perform overlap detection at the printer, thereby reducing the processing burden at the printer.

According to a first aspect of the invention, there is provided a method of printing an image, the method comprising the steps of:

generating at a host, from an image to be printed, a display list representation of a visually equivalent image comprising non-overlapping graphic objects; and

scan-line rendering, using the display list representation, the visually equivalent image at a printer communicating with the host, without performing overlap detection at the printer.

According to another aspect of the invention, there is provided a method of converting a representation of first image, having a first set of overlapping graphic objects, into a display list representation of a visually equivalent second image, having a second set of non overlapping graphic objects, said method comprising the steps of:

(a) categorising each graphic object in the first set as being one of (i) a fully visible graphic object, (ii) a partly visible graphic object, and (iii) an invisible graphic object;

(b) defining, in relation to each said fully visible graphic object in said first set, a substantially identical graphic object in the second set; and

(c) defining, in relation to visible regions of each said partly visible graphic object in said first set, one or more graphic objects being visually equivalent to the partly visible graphic object, in the second set.

According to another aspect of the invention, there is provided a method of converting a representation of a first image, having a first set of graphic objects spanning a plurality of layers, into a display list representation of a visually equivalent second image, having a second set of graphic objects on a single layer, said method comprising the steps of:

(a) categorising each graphic object in the first set as being one of (i) a fully visible graphic object, (ii) a partly visible graphic object, and (iii) an invisible graphic object;

(b) defining, in relation to each said fully visible graphic object in said first set, a substantially identical graphic object in the second set; and

(c) defining, in relation to visible regions of each said partly visible graphic object in said first set, one or more graphic objects being visually equivalent to the partly visible graphic object, in the second set.

According to another aspect of the invention, there is provided a method of converting, on a scanline basis, a representation of a first image having a first set of overlapping graphic objects, into a display list representation of a visually equivalent second image having a second set of non overlapping graphic objects, said method comprising, for a current scanline, the steps of:

(a) determining, in a current scanning direction, a leading and a lagging edge of a visible region of a first one of said graphic objects in said first set;

(b) defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;

(c) defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:

(d) repeating steps (a) to (d) for all successive pairs of leading and lagging edges on the scanline; wherein said pairs of leading and lagging edges establish the second set of visually equivalent graphic objects for said current scanline.

According to another aspect of the invention, there is provided a method of converting, on a scanline basis, a representation of a first image having a first set of graphic objects spanning a plurality of layers, into a display list representation of a visually equivalent second image having a second set of graphic objects on a single layer, said method comprising, for a current scanline, the steps of:

(a) determining, in a current scanning direction, a leading and a lagging edge of a visible region of a first one of said graphic objects in said first set;

(b) defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;

(c) defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:

(d) repeating steps (a) to (d) for all successive pairs of leading and lagging edges on the scanline; wherein said pairs of leading and lagging edges establish the second set of visually equivalent graphic objects for said current scanline.

According to another aspect of the invention, there is provided an apparatus for printing an image, the apparatus comprising:

means for generating at a host, from an image to be printed, a display list representation of a visually equivalent image comprising non-overlapping graphic objects; and

means for scan-line rendering, using the display list representation, the visually equivalent image at a printer communicating with the host, without performing overlap detection at the printer.

According to another aspect of the invention, there is provided an apparatus for converting a representation of first image, having a first set of overlapping graphic objects, into a display list representation of a visually equivalent second image, having a second set of non overlapping graphic objects, said apparatus comprising:

(a) means for categorising each graphic object in the first set as being one of (i) a fully visible graphic object, (ii) a partly visible graphic object, and (iii) an invisible graphic object;

(b) means for defining, in relation to each said fully visible graphic object in said first set, a substantially identical graphic object in the second set; and

(c) means for defining, in relation to visible regions of each said partly visible graphic object in said first set, one or more graphic objects being visually equivalent to the partly visible graphic object, in the second set.

According to another aspect of the invention, there is provided an apparatus for converting a representation of a first image, having a first set of graphic objects spanning a plurality of layers, into a display list representation of a visually equivalent second image, having a second set of graphic objects on a single layer, said apparatus comprising:

(a) means for categorising each graphic object in the first set as being one of (i) a fully visible graphic object, (ii) a partly visible graphic object, and (iii) an invisible graphic object;

(b) means for defining, in relation to each said fully visible graphic object in said first set, a substantially identical graphic object in the second set; and

(c) means for defining, in relation to visible regions of each said partly visible graphic object in said first set, one or more graphic objects being visually equivalent to the partly visible graphic object, in the second set.

According to another aspect of the invention, there is provided an apparatus for converting, on a scanline basis, a representation of a first image having a first set of overlapping graphic objects, into a display list representation of a visually equivalent second image having a second set of non overlapping graphic objects, said apparatus comprising:

(a) means for determining, in a current scanning direction, a leading and a lagging edge of a visible region of a first one of said graphic objects in said first set;

(b) means for defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;

(c) means for defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:

(d) means for repeating steps (a) to (d) for all successive pairs of leading and lagging edges on the scanline; wherein said pairs of leading and lagging edges establish the second set of visually equivalent graphic objects for said current scanline.

According to another aspect of the invention, there is provided an apparatus for converting, on a scanline basis, a representation of a first image having a first set of graphic objects spanning a plurality of layers, into a display list representation of a visually equivalent second image having a second set of graphic objects on a single layer, said apparatus comprising:

(a) means for determining, in a current scanning direction, a leading and a lagging edge of a visible region of a first one of said graphic objects in said first set;

(b) means for defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;

(c) means for defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:

(d) means for repeating steps (a) to (d) for all successive pairs of leading and lagging edges on the scanline; wherein said pairs of leading and lagging edges establish the second set of visually equivalent graphic objects for said current scanline.

According to another aspect of the invention, there is provided a computer program for directing a processor to execute a method of converting a representation of first image, having a first set of overlapping graphic objects, into a display list representation of a visually equivalent second image, having a second set of non overlapping graphic objects, said program comprising:

(a) code for categorising each graphic object in the first set as being one of (i) a fully visible graphic object, (ii) a partly visible graphic object, and (iii) an invisible graphic object;

(b) code for defining, in relation to each said fully visible graphic object in said first set, a substantially identical graphic object in the second set; and

(c) code for defining, in relation to visible regions of each said partly visible graphic object in said first set, one or more graphic objects being visually equivalent to the partly visible graphic object, in the second set.

According to another aspect of the invention, there is provided a computer program for directing a processor to execute a method of converting a representation of a first image, having a first set of graphic objects spanning a plurality of layers, into a display list representation of a visually equivalent second image, having a second set of graphic objects on a single layer, said program comprising:

(a) code for categorising each graphic object in the first set as being one of (i) a fully visible graphic object, (ii) a partly visible graphic object, and (iii) an invisible graphic object;

(b) code for defining, in relation to each said fully visible graphic object in said first set, a substantially identical graphic object in the second set; and

(c) code for defining, in relation to visible regions of each said partly visible graphic object in said first set, one or more graphic objects being visually equivalent to the partly visible graphic object, in the second set.

According to another aspect of the invention, there is provided a computer program for directing a processor to execute a method of converting, on a scanline basis, a representation of a first image having a first set of overlapping graphic objects, into a display list representation of a visually equivalent second image having a second set of non overlapping graphic objects, said program comprising, in relation to a current scanline:

(a) code for determining, in a current scanning direction, a leading and a lagging edge of a visible region of a first one of said graphic objects in said first set;

(b) code for defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;

(c) code for defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:

(d) code for repeating steps (a) to (d) for all successive pairs of leading and lagging edges on the scanline; wherein said pairs of leading and lagging edges establish the second set of visually equivalent graphic objects for said current scanline.

According to another aspect of the invention, there is provided a computer program for directing a processor to execute a method of converting, on a scanline basis, a representation of a first image having a first set of graphic objects spanning a plurality of layers, into a display list representation of a visually equivalent second image having a second set of graphic objects on a single layer, said program comprising, in relation to a current scanline:

(a) code for determining, in a current scanning direction, a leading and a lagging edge of a visible region of a first one of said graphic objects in said first set;

(b) code for defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;

(c) code for defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:

(d) code for repeating steps (a) to (d) for all successive pairs of leading and lagging edges on the scanline; wherein said pairs of leading and lagging edges establish the second set of visually equivalent graphic objects for said current scanline. Other aspects of the invention are also disclosed.

### BRIEF DESCRIPTION OF THE DRAWINGS

One or more embodiments of the present invention will now be described with reference to the drawings, in which:

FIG. 1 shows a functional block diagram for a PC based printing system;

FIG. 2 shows a printing process flow diagram used in the system of FIG. 1;

FIG. 3 shows a general purpose computer system upon which disclosed arrangements can be practiced;

FIG. 4 illustrates overlapping graphic objects;

FIG. 5 shows equivalent non-overlapping graphic objects;

FIG. 6 depicts active edge lists for conventional and non-intersecting object arrangements;

FIG. 7 depicts a process for converting overlapping graphic objects into equivalent non-overlapping graphic objects.

FIG. 8 depicts a dataflow diagram for production, updating and use of edge lists;

FIGS. 9 and 10 show process flow diagram fragments for producing non-overlapping graphic objects in the PCP host processor;

FIG. 11 shows a process flow diagram for rendering the non-overlapping object representation received from the PCP to sequential pixels in the printer ERP processor;

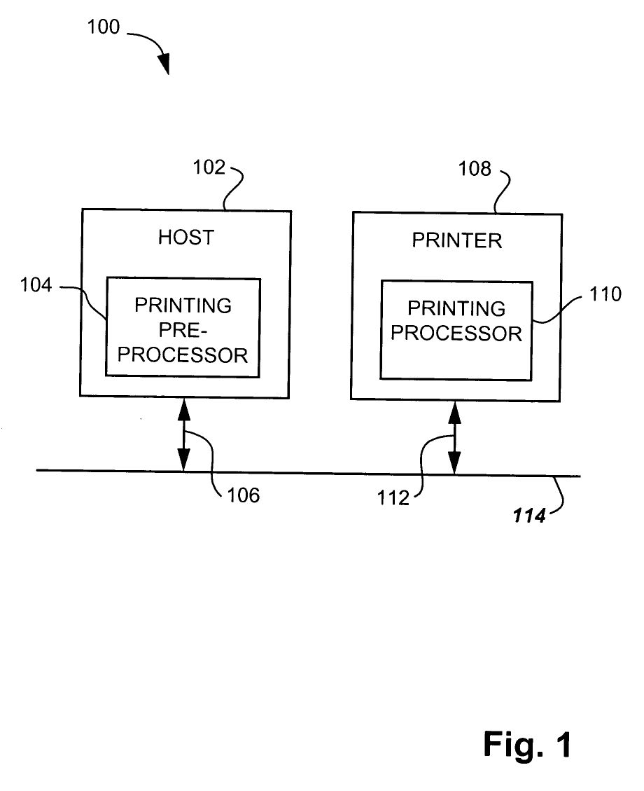

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

The present description discloses a new rendering architecture in which the scanline processing step 310, which is performed by the host processor 104, generates a simplified graphic object display list representation which is transmitted over the communication bus 114 to the printer processor 110. The simplified object representation, which is based upon converting the object representation generated by the step 306 into an equivalent non-overlapping and non-self-intersecting object representation, is suitable for rendering by a relatively inexpensive printing processor 110 in the step 314. The disclosed approach requires transmission of less data over the communication bus 114 than required by the bitmap approach, and does not require the printer processor 110 to be as powerful as is dictated by the display list approaches previously described. Using the new architecture, printers can provide significantly greater printing throughput than conventional bitmap approaches, at a lower cost than that of conventional display list arrangements. The disclosed new architecture refers to the host processor 104 as the PC pre-processor (PCP), while the printer processor 110 in the printer 108 is referred to as the Embedded Rendering Processor (ERP).

The disclosed new architecture provides significant advantages over the conventional display list approach which generates a “complete” display list in the host processor 104, and sends this complete display list to the printer. In the conventional display list approaches the printer processor 110 must consider, at a given pixel X position on a particular scanline Y, all edges of all active objects when deciding upon a value for the pixel. Since at X, an arbitrary number of objects may be active, the computation required by the printer processor 110 in the conventional display list approaches increases linearly for each additional object present on the printed page. The designer of conventional display list printers must therefore select a printer processor 110 that can perform adequately under this potential processing burden. The new architecture significantly reduces the burden on the printer processor 110 which need only consider a “flat” object representation which is equivalent to the print data in the job to be printed, but which is represented as an equivalent non-overlapping and non-self-intersecting object representation. The new architecture distributes rendering of a print job between the powerful host 102 and a “weak” slave 108 utilising an efficient compact representation between the two.

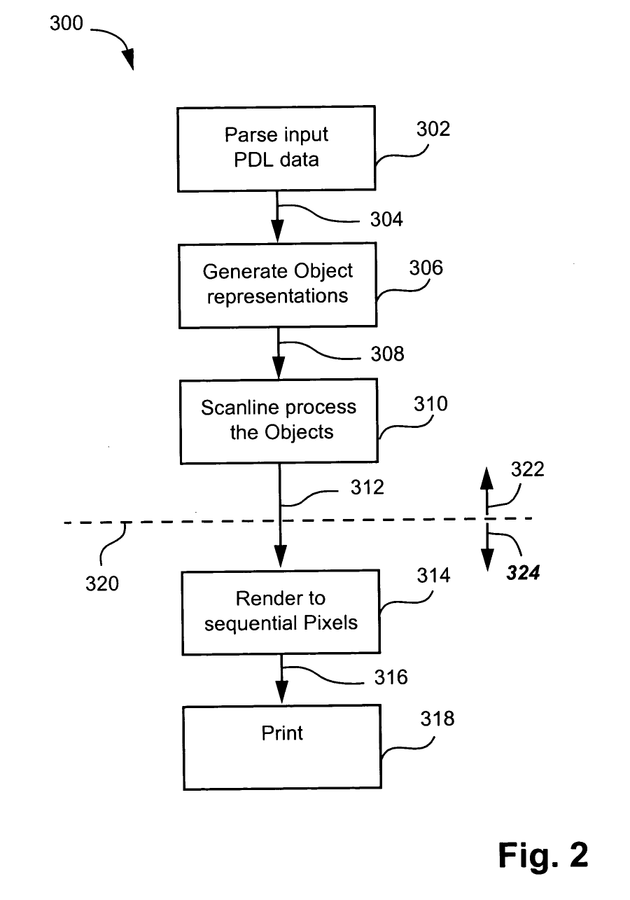

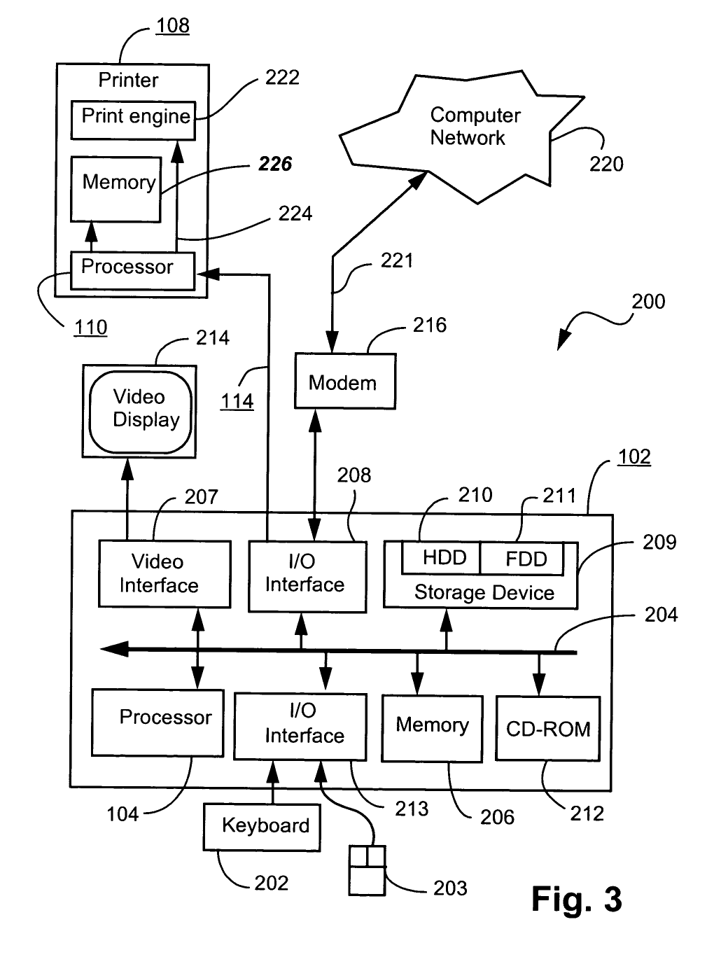

FIG. 3 shows how the new printing architecture is preferably practiced using a general-purpose computer system 200. The system 200 includes the host 102, the host processor (PCP) 104, the printer 108, and the print processor (ERP) 110, as shown in FIG. 3. The processes of FIGS. 2, and 7-11 may be implemented as software, such as an application program executing within the computer system 200. In particular, the printing method steps are effected by instructions in the software that are carried out by the system. The instructions may be formed as one or more code modules, each for performing one or more particular tasks. The software may also be divided functionally into two code parts, in which a first code part performs the printing method steps and a second part manages a user interface between the first part and the user. The software can also be divided into two physical parts, one part stored and processed in the host 102, and one part stored and processed in the printer 108. The physical partitioning of the software can be carried out largely independently of the functional partitioning. The software may be stored in a computer readable medium, including the storage devices described below, for example. The software is loaded into the system from the computer readable medium, and then executed by the system 200. A computer readable medium having such software or computer program recorded on it is a computer program product. The use of the computer program product in the system 200 preferably effects an advantageous apparatus for implementing the new printing architecture.

The computer system 200 comprises the host computer module 102, input devices such as a keyboard 202 and mouse 203, output devices including the printer 108, (which includes the ERP 110, a memory 226 and a printer engine 222), and a display device 214. The printer 108 is connected to the host computer 102 by the communication bus 114. A Modulator-Demodulator (Modem) transceiver device 216 is used by the host computer module 102 for communicating to and from a communications network 220, for example connectable via a telephone line 221 or other functional medium. The modem 216 can be used to obtain access to the Internet, and other network systems, such as a Local Area Network (LAN) or a Wide Area Network (WAN).

The host computer module 102 typically includes at least one processor unit being the PCP 104, a memory unit 206, for example formed from semiconductor random access memory (RAM) and read only memory (ROM), input/output (I/O) interfaces including a video interface 207, and an I/O interface 213 for the keyboard 202 and mouse 203 and optionally a joystick (not illustrated), and an interface 208 for the modem 216. A storage device 209 is provided and typically includes a hard disk drive 210 and a floppy disk drive 211. A magnetic tape drive (not illustrated) may also be used. A CD-ROM drive 212 is typically provided as a non-volatile source of data. The components 104 and 206 to 213 of the host computer module 102, typically communicate via an interconnected bus 204 and in a manner that results in a conventional mode of operation of the host computer system 102 known to those in the relevant art. Examples of computers on which the described arrangements can be practised include 13M-PC's and compatibles, Sun Sparcstations or alike computer systems evolved therefrom.

Typically, the application program is physically resident (i) on the host hard disk drive 210 and read and controlled in its execution by the PCP 104, and (ii) in the printer memory 226 and read and controlled in its execution by the ERP 110. Intermediate storage of the program and any data fetched from the network 220 may be accomplished using the semiconductor memory 206, possibly in concert with the hard disk drive 210 and the printer memory 226. In some instances, the application program may be supplied to the user encoded on a CD-ROM or floppy disk and read via the corresponding drive 212 or 211, or alternatively may be read by the user from the network 220 via the modem device 216. Still further, the software can also be loaded into the computer system 200 from other computer readable media. The term “computer readable medium” as used herein refers to any storage or transmission medium that participates in providing instructions and/or data to the computer system 200 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the host computer module 102. Examples of transmission media include radio or infrared transmission channels as well as a network connection to another computer or networked device, and the Internet or Intranets including email transmissions and information recorded on websites and the like.

The new printing architecture may alternatively be implemented in dedicated hardware such as one or more integrated circuits performing the functions or sub functions of printing in accordance with the new architecture. Such dedicated hardware may include graphic processors, digital signal processors, or one or more microprocessors and associated memories.

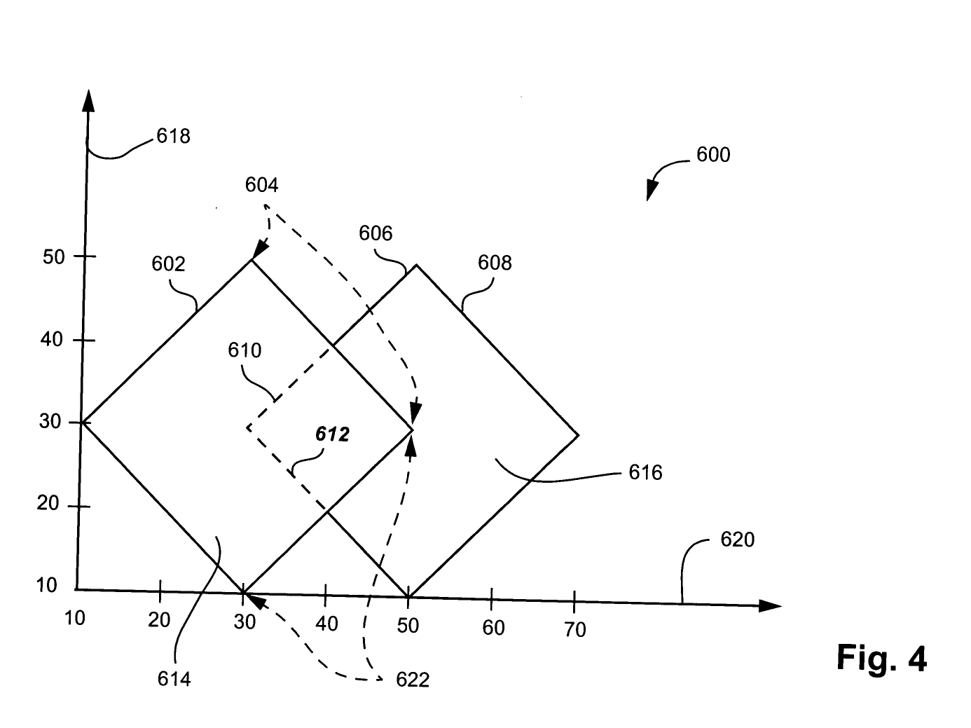

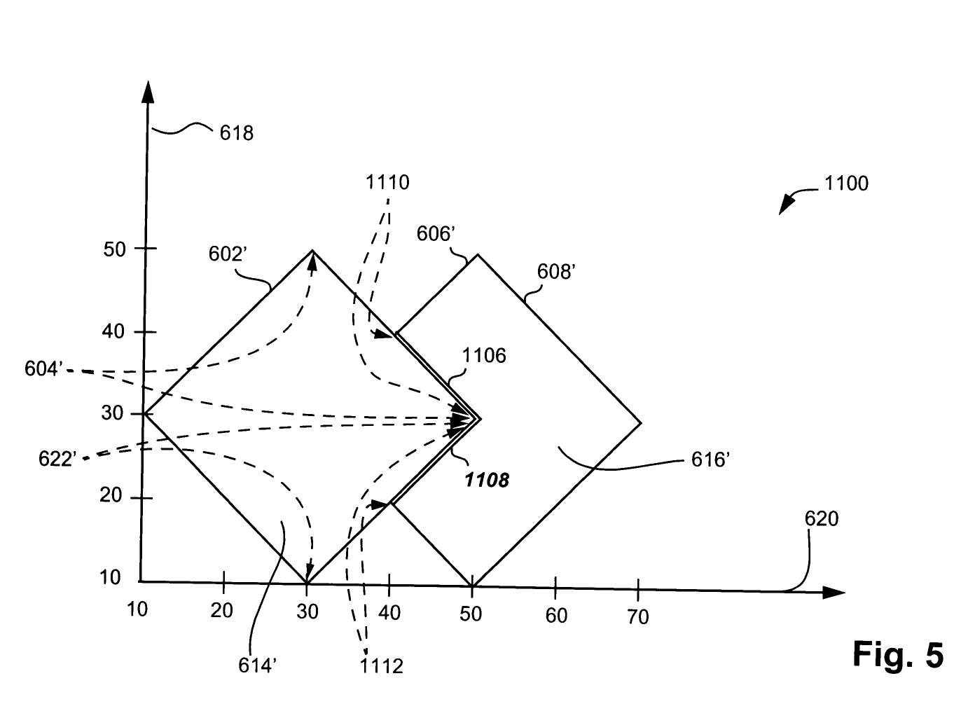

The PCP 104 produces, in the step 310, a display list representation of the objects to be painted onto the page. The display list representation provided by the PCP relates however, in contrast to the complete display list provided by conventional display list printers, to a set of printably equivalent non-overlapping objects which may be painted onto the output page without any regard for overlap. FIGS. 4 and 5 illustrate the equivalence between conventional and flat object representations.

FIG. 4 shows two diamond shapes 614 and 616 positioned with reference to a pair of mutually perpendicular axes 618 and 620. The diamond shape 614 overlaps the diamond shape 616 as depicted by dashed line segments 610 and 612.

FIG. 5 shows equivalent diamond shapes 614′ and 616′ where the overlapped line segments 610 and 612 have been expunged from the representation. FIG. 5 shows how the edge 604 of the diamond shape 614 (see FIG. 4) has been preserved, as depicted by the reference numeral 604′. However, a “new” edge 1106 has been generated to account for the intersection between the diamond shape 614 and the diamond shape 616 along the edge 604. Similarly, a new edge 1108 has been generated to account for the intersection between the diamond shape 614 and the diamond shape 616 along the edge 622.

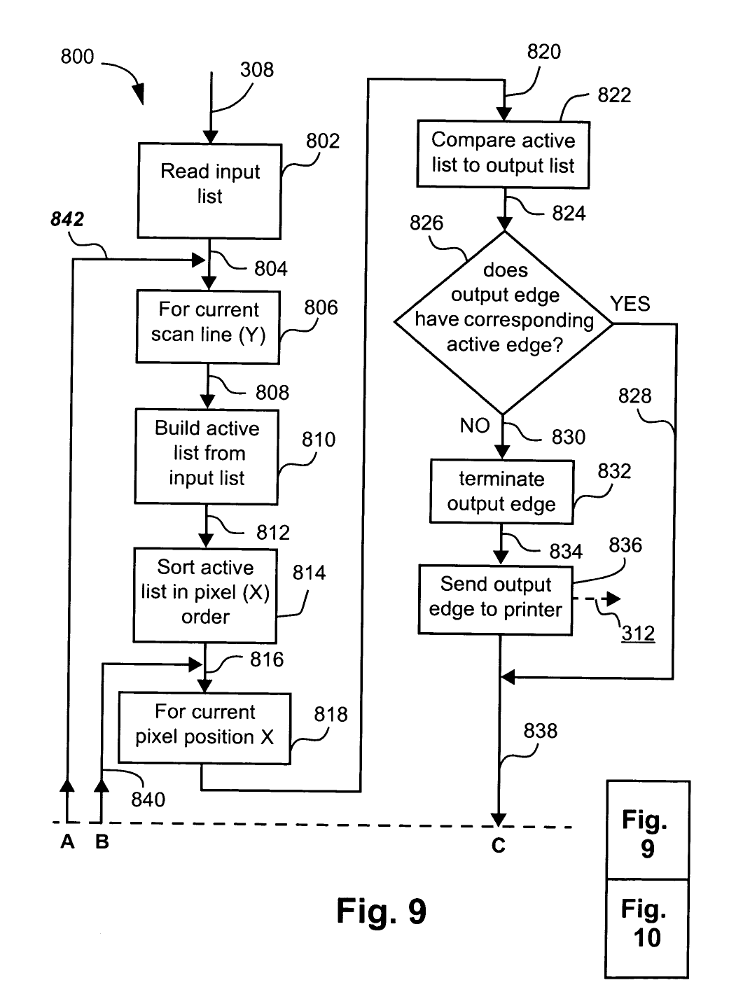

FIG. 5 depicts an arrangement wherein the additional edges 1106 and 1108 have been generated in order to account for the intersection between the diamond shapes 614 and 616 along the edges 604 and 622 respectively. Alternately, the edge segments 1110 and 1112 can serve the dual purpose of acting both (i) as edges of the diamond shape 614′, and (ii) as edges of the diamond shape 616′. It is, in fact, this latter approach which is described in more detail in regard to FIGS. 9 to 11. Although only two exemplary approaches have been described in order to represent overlapping objects in terms of equivalent non-overlapping objects, other approaches that achieve the same conversion from overlapping to non-overlapping equivalent representations may also be used.

The new disclosed printing architecture generates the equivalent non-overlapping representation of objects in the PCP 104 in the method step 310, and this non-overlapping representation is passed to the ERP 110 over the communication bus 114, for further processing by the ERP 110 in the step 314. The non-overlapping object representation can be rendered by the ERP 110 using significantly less computational power than would be required in the conventional display list approach, since the ERP requires, at most, to process an individual object at each pixel position. The non-overlapping object representation replaces a plurality of objects at each pixel location with a single object, thereby limiting the processing to a known maximum processing burden per pixel. Accordingly, the worst case computational burden can be calculated in advance, and used to select a particular processor device for the ERP 110 in the particular printer 108 to be manufactured.

In broad terms, processing by the PCP 104 involves tracking the edges of graphic objects falling on a particular scanline Y. At the decision stage for determining a pixel value output for a given pixel position X, the PCP outputs either the edge of an existing object from the print job, or a new synthesised edge. New synthesised edges are generated at the edge intersection between overlapping objects, as has been described with reference to FIGS. 4 and 5. If the approach exemplified in FIG. 5 is adopted, then a new edge is generated, as exemplified by the edge segments 1106 and 1108, for example. If, on the other hand, the approach is adopted wherein the edge segment 1110 acts as both the edge segment for the object 614′ as well as the edge segment for the object 616′, then the new synthesized edge is actually represented by an indicator tagged to the edge segment 1110 indicating that the edge segment serves a dual purpose.

Whether the original print job contains overlapping objects, and/or self intersecting objects, the PCP 104 generates multiple non-intersecting objects which represent, equivalently, the overlapping and/or self-intersecting objects. This approach has the remarkable effect of providing the ERP 110 with a print job comprising a plurality of non-overlapping/non-self intersecting objects, thereby significantly reducing the processing burden on the ERP 110, and defining a maximum processing burden envelope for the ERP 110.

The fact that all ERP objects are non-overlapping and non-self intersecting implies that the order of objects in an ERP job (as represented by an edge list) is fixed in first “Y” position, and then in “X” scanline order. No re-order of edges in the edge list is required, in contrast to conventional display list approaches, in which edge list reordering is required when multiple overlapping and/or intersecting edges are being considered.

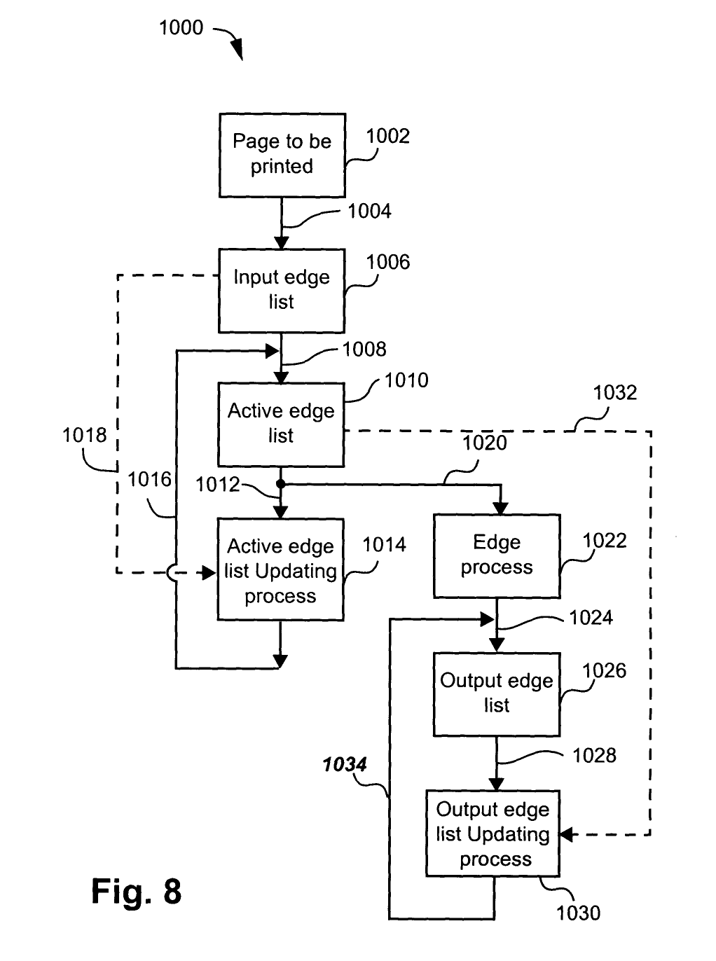

The disclosed printing architecture makes use of a number of edge lists which will be described in more detail with reference to FIGS. 8-11. As introductory background, however, it is noted that an “input” or PCP edge list is used to represent the object representations in the original print job. An “active” edge list tracks edges for a current scan line, and an “output” or ERP edge list is that edge list that is sent from the host 102 over the bus 114 to the printer 108 for processing by the printer ERP 112 and subsequent printing.

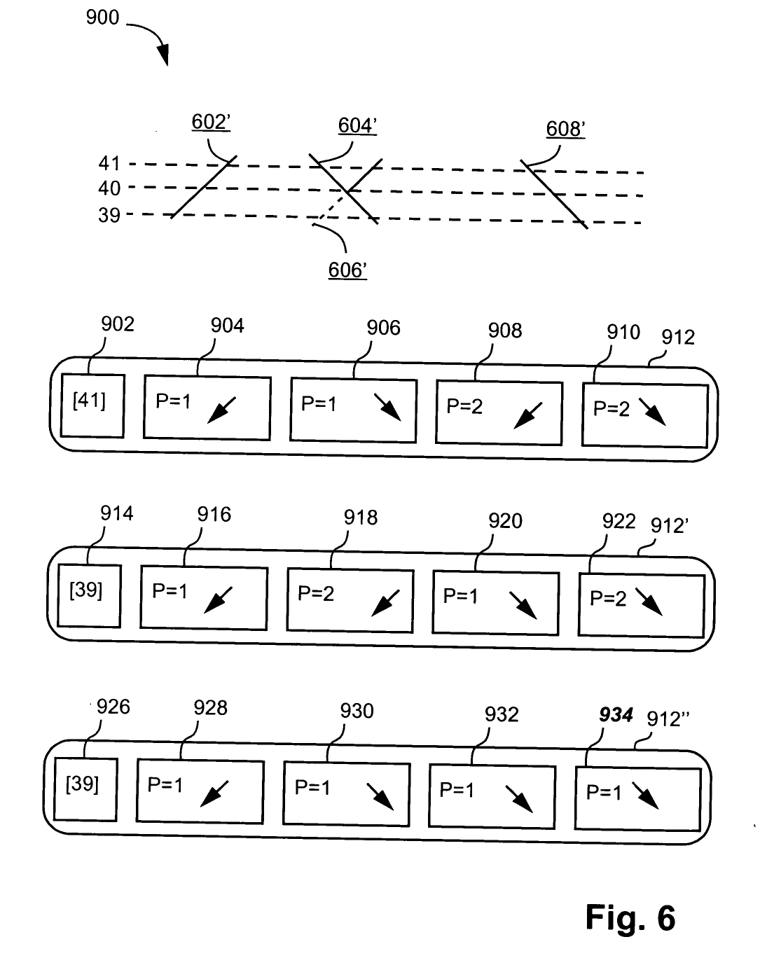

FIG. 6 illustrates contents of active edge lists, for both conventional display list arrangements and the disclosed non-intersecting object edge list approach, for scanlines 39 to 41 of FIGS. 4 and 5. The edges 602′, 604′, 606′ and 608′ are depicted as they intersect scanlines 41 to 39 at the top of FIG. 6. An active edge list 912 for the conventional display list arrangement contains a scanline identifier 902 as well as edge data 904-910 for the aforementioned edges as they refer to the scanline 41. Accordingly, the data block 904 contains priority information “P=1” indicating that the object associated with the edge 602′ is the top (ie visible) object. The arrow segment in the data block 904 is oriented in a position that corresponds to the orientation of the edge 602′. The adjacent data block 906 corresponds to the edge 604′ and contains the appropriate priority and edge orientation information. Similarly, the data blocks 908 and 910 contain priority levels of “P=2” indicating that the object 616′ is one level below the object 614.

The active edge list 912′, also referred to in conventional display list arrangements, contains data blocks 914-922 which correspond to the edges 602′-608′ for the scanline no. 39. It will be apparent that the active edge list 912′ has been re-ordered so that the data block 918 represents the edge segment 606′ whereas the data block 920 represents the edge segment 604′. This re-ordering is necessary to account for the fact that the edges 604′ and 606′ cross over between the scanline nos. 41 and 39. This requirement for re-ordering is a feature of traditional display list approaches, and is one of the features leading to the significant computation burden on the printer process 110.

In contrast, the active edge list 912″, used in the disclosed non-overlapping object approach, corresponds to the non-overlapping objects 614′ and 616′ for scanline no. 39. Accordingly, while the data blocks 928 and 934 mirror, apart from priority flags, the data blocks in the previous active edge lists 912 and 912′, the data blocks 930 and 932 represent the edges 1110 and 1106 in FIG. 5. It will be apparent that the active edge list 912″ is different from the previous active edge lists in a number of regards. In the first instance, although a priority level of “P=1” is shown in each data block, this priority flag is in fact redundant since all objects are at the same level. Furthermore, there is no need to re-order active edge list data blocks, since as edges expire they are merely removed from the active edge list, and new edges are merely inserted at the correct “X” location in the active list. The maximum number of active edges is fixed for a page, and can approach at most the number of pixels on a scanline.

As the PCP 104 scanline converts a page for printing in the step 310, the output generated is accumulated into a display list of non-overlapping/non-intersecting ERP objects (ie the output ERP edge list) which is communicated to the ERP 110 over the communication bus 114.

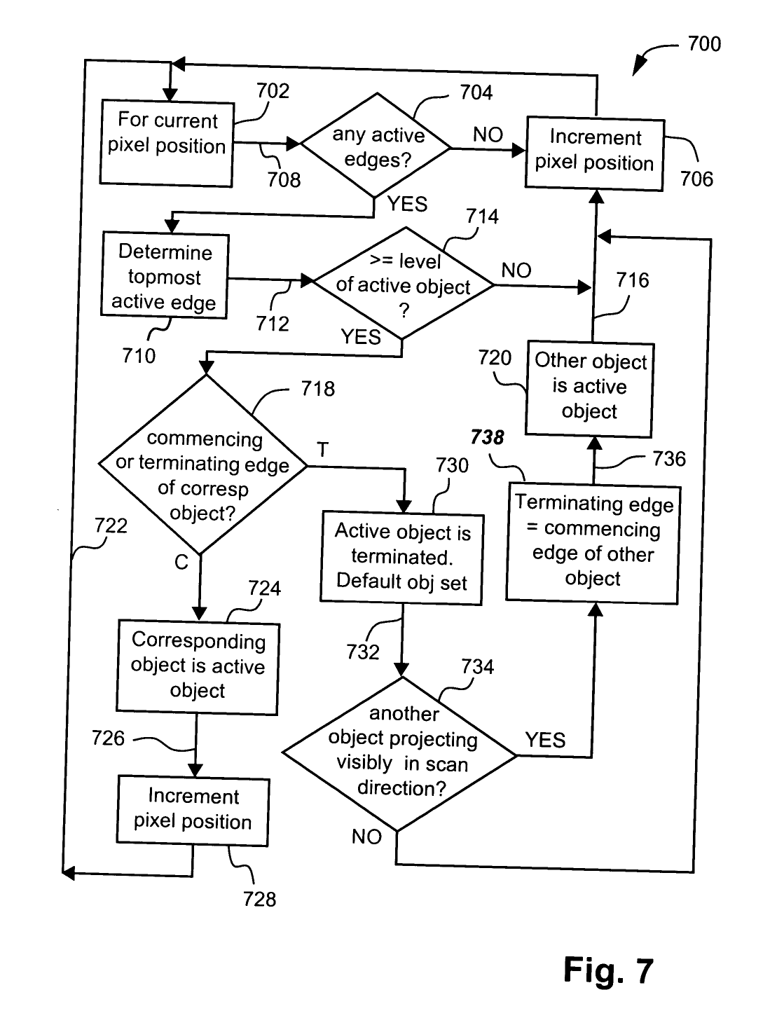

FIG. 7 depicts a process 700 for converting overlapping objects exemplified by the objects 614 and 616 into equivalent non-overlapping objects as exemplified by the objects 614′ and 616′. The process 700 commences with a step 702 that indicates that a current pixel position is being considered (with reference to an arbitrary scan line). Thereafter, a testing step 704 determines whether there are any active edges at the present pixel position. If there are none, then the process 700 is directed in accordance with a “N” arrow to a step 706 that increments the pixel position, and returns the process to the step 702.

If there are active edges at the step 704, however, then the process 700 is directed to a step 710 that determines the topmost one of such edges. A following testing step tests whether the detected topmost edge is at a level equal to or greater than the “active object”. (This active object will either be set, in a step 730, at a default level, being a level below which no “real” object can be positioned, or will be set, in steps 724 and 720, to be actual objects). If the detected topmost edge is indeed greater than or equal to the level of the active object, then the process 700 is directed in accordance with a “YES” arrow to a testing step 718. This step tests whether the edge is a leading edge of the corresponding object (such as the edge 602′ on the scan line 41 in FIG. 6) or the lagging edge (such as the edge 604′ on the scan line 41 in FIG. 6).

If the edge is a commencing edge, then the process 700 is directed in accordance with a “C” arrow to a step 724 which defines the corresponding object to be the active object. If the edge is a terminating edge, then the process 700 is directed in accordance with a “T” arrow to a step 730 that terminates the active object, and sets the default active object at the aforementioned very low level.

Once the step 724 sets the object corresponding to the detected topmost commencing edge as the active edge, then the process 700 is directed in accordance with an arrow to a step 728 that increments the pixel position, and returns the process to the step 702 with an arrow 722.

After the step 730 in which the active object has been terminated because the detected edge was a terminating step, the process 700 is directed to a testing step 734. This step tests whether another object is projecting visibly beyond the previously defined active object in the scanning direction from beneath the previously defined active object. If there is such a projecting object, then the process 700 is directed in accordance with a “YES” arrow to a step 738 that defines the previously mentioned terminating edge as being the commencing edge of the detected projecting object. This was described as the variant of the method described in relation to FIG. 5. Thereafter, a step 720 defines the “other” projecting object to be the active object, and the process 700 is directed in accordance with an arrow 716 to the step 706.

If there is no other object projecting visibly from beneath the aforementioned terminated object in the step 734, then the process 700 is directed in accordance with a “NO” arrow to the step 706.

Although the print architecture disclosed is primarily directed to rendering object representations on a printed page, an additional capability can be supported relating to bit-map data. Accordingly, during scan conversion, the PCP 104 can also keep track of memory consumed by the edge lists, and can generate a bit map representation of the page in parallel. During normal operation, this bit map representation would be discarded. However, if the PCP 104 detects that the ERP (output) edge list (ie., the non-overlapping/non-self intersecting object representation) is larger than the equivalent bit map (which might happen, for example, if there are a large number of single pixel objects), then the PCP 104 can utilise the bit map representation generated instead of the display list for the ERP 110. The PCP 104 can also simply calculate the amount of memory used by the ERP object representation, and can decide to generate the bit map after verifying whether the ERP representation is large enough to necessitate this alternative. This last step is performed by interpreting the ERP display list, and then discarding it.

Accordingly, either the ERP representation or the bit map can be sent to the print engine 222, depending on the factors noted above.

In another arrangement, the PCP 104 can render the page to be printed in bands. In this case, the ERP objects are generated in fixed vertical band sizes. In this arrangement, the decision as to whether to send ERP objects or equivalent bit maps to the print engine 222 can be made on a per-band basis.

The overlapping diamond shapes 614 and 616 shown in FIG. 4 can be represented by the following Adobe postscript description (to be referred to as description [1]):

/DeviceRGB setcolorspace

255 255 0 setcolor

30 10 moveto

50 30 lineto

30 50 lineto [1]

10 30 lineto

closepath

fill

255 0 255 setcolor

50 10 moveto

70 30 lineto

50 50 lineto

30 30 lineto

closepath

fill

showpage

This Adobe postscript description can be converted by known methods (see “Computer Graphics Principles and Practice” by Foley, Van Dam, Feiner, and Hughes; Addison-Wesley; ISBN 0-201-12110-7) to the following object representation (to be referred to as description [2]), as performed in the step 306 of FIG. 2:

Setting Color: “Color”<red>,<green>,<blue>

Filled Polygon: “FillPoly”<x, y>[, <x, y>] ‘;’[2]

|Color: 255,255,0 |FillPoly: 30,10,50,30,30,50,10,30,30,10;|

|Color: 255,0,255 |FillPoly: 50,10,70,30,50,50,30,30,50,10;|

The above object representation [2] represents an input (PCP) edge list for the scanline process of the step 310 in FIG. 2.

FIG. 8 depicts a dataflow diagram relating to production, updating and use of edge lists used by the PCP 104 and the ERP 110. The input page for printing is represented at a block 1002, this page being converted in the step 306 to an input edge list 1006 (exemplified by the PCP edge list [1]). The input edge list is processed, on a per scanline basis, to provide a per-scanline active edge list 1010 which is updated in an updating process 1014. The active edge list updating process 1014 makes use both of the active edge list itself 1010 and the input edge list 1006 as depicted by an arrow 1012 and a dashed arrow 1018 respectively. The active edge list is also processed in an edge process 1022 which produces an output edge list 1026 (exemplified by an ERP edge list [3] described below). The output edge list is updated in the output edge list updating process 1030 which makes use both of the output edge list 1026 as depicted by an arrow 1028 and the active edge list 1010 as depicted by a dashed arrow 1032.

The output (ERP) edge list [3], derived from the exemplary input (PCP) edge list [2], takes the following form, which represents the objects 614′ and 616′ in terms of their non-overlapping and non-intersecting edges:

Setting Color: “Color”<red>,<green>,<blue>

Polygon Edge: “Edge”<x, starting-y, ending-y, gradient>

|Color: 255,255,0|Edge: 30,50,30, −1|

|Color: 255,255,2551 Edge: 30,50,40,1 |

|Color: 255,0,255|Edge: 50,50,40,−1

|Color: 255,255,255|Edge: 50,50,30,1|

|Color: 255,0,255|Edge: 40,40,30,1|

|Color: 255,255,0|Edge: 10,30,10,1|

|Color: 255,0,255|Edge: 50,30,20, −1|

|Color: 255,255,255|Edge: 70,30,10,−1|

|Color: 255,255,255|Edge: 40,20,10,−1|

|Color: 255,0,255|Edge: 40,20,10,1|

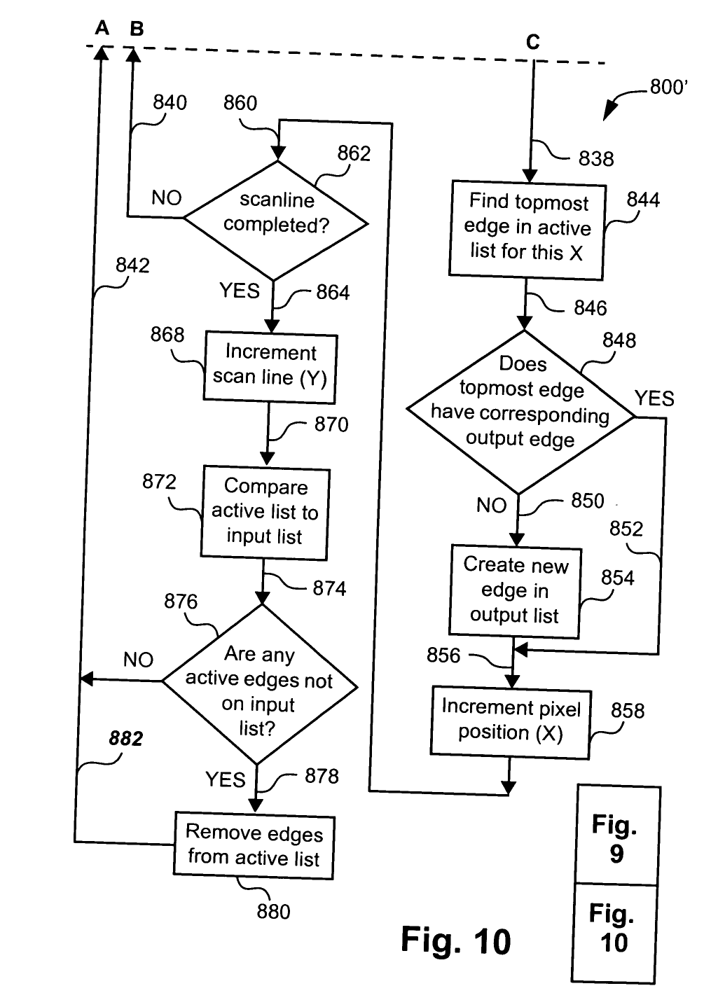

FIGS. 9 and 10 show a flow diagram comprising two flow diagram segments 800 and 800′ for a process by which the PCP 104 produces a non-overlapping object graphic description (exemplified by the output edge list [3] from an input edge list exemplified by [2].) The process fragments 800 and 800′ depict the process 310 of FIG. 2 in more detail. The process depicted in FIGS. 9 and 10 is also presented in pseudo-code format in Appendix A. Appendix A relates to the process 300 of FIG. 2 insofar as the host machine 102 is concerned, namely up to the boundary 320. Appendix A thus relates to steps 302, 306 and 310 in FIG. 2.

FIG. 9 relates to the process fragment 800, and commences with a step 802 (see Appendix A lines 173 to 178) that reads the input list [2]. Thereafter, a step 806 (see Appendix A line 173) indicates that following steps are performed for a current scanline. A subsequent step 810 (see Appendix A lines 174 to 177) builds an active list, exemplified in FIG. 6, from the input list [2]. Thereafter, a step 814 (see Appendix A line 186) sorts the active list into pixel (X) order. Thereafter, a step 818 (see Appendix A lines 198 to 378) indicates that following sub-steps are performed for a current pixel position X.

A subsequent step 822 (see Appendix A lines 198 to 379) compares the active list, built in the step 810 (see Appendix A lines 174 to 177), to the output list. A subsequent testing step 826 (see Appendix A lines 206 to 216) decides whether an output edge in the output list at the current pixel position has a corresponding active edge in the active list. If this is the case, then the process fragment 800 is directed in accordance with a “yes” arrow to an arrow 838 (which continues in FIG. 10 on the arrow segment 838). If, on the other hand, the testing step 826 (see Appendix A lines 206 to 216) returns a “no”, then the process fragment 800 is directed in accordance with an arrow 830 to a step 832 (see Appendix A lines 214 to 215) which terminates the output edge that has been considered. A subsequent step 836 sends the terminated output edge to the printer 110 (as depicted by a dashed arrow 312) for processing in the step 314 of FIG. 2. The sequence of output edges [3] depicted by the arrow 312 constitutes the (simplified) display list representation of the image having non-overlapping graphic objects that is sent to the printer for rendering, this being visually equivalent to the image represented by the input list [2].

FIG. 10 shows the continuation process fragment 800′ and in particular, a step 844 (see Appendix A lines 239 and 116 to 131) continues from the arrow segment 838, and finds a topmost edge (ie the edge having the highest level flag) in the active list for the X being considered. A subsequent testing step 848 (see Appendix A lines 291 and 305 to 312) determines whether the topmost edge in the active list has a corresponding output edge. If this is, in fact the case, then the process segment 800′ is directed in accordance with a “yes” arrow to a step 858 (see Appendix A line 195) which checks the pixel position (ie., X) being considered. If, on the other hand, the testing step 848 (see Appendix A lines 291 and 305 to 312) determines that the topmost edge in the active list does not have a corresponding output (ERP) edge in the output, then the process segment 800′ is directed in accordance with a “NO” arrow to a step 854 (see Appendix A lines 292 to 300 or lines 313 to 377) which creates a new edge in the output list. It is this step 854 (see Appendix A lines 292 to 300 and lines 313 to 377) which creates both new existing edges, such as the edge 604′ in FIG. 5, and new synthesized edges which are acquired for object intersections, such as the edge segment 1106 or the dual-purpose edge segment 1110.

The process segment 800′ is then directed to a testing step 862 (see Appendix A line 195) that determines whether the present scanline has been completed. If this is not the case, then the process segment 800′ is directed in accordance with a “no” arrow (ie., 840) to the arrow segment 840 in FIG. 9 and thereby back to the step 818 (see Appendix A lines 198 to 378). If, on the other hand, the present scanline has been completed, then the process fragment 800′ is directed in accordance with a “yes” arrow to a step 868 (see Appendix A line 383) which increments the scanline (Y). A subsequent step 872 (see Appendix A lines 388 to 413) then compares the active list, exemplified in FIG. 6, with the current scanline (Y). Thereafter, a testing step 876 (see Appendix A line 389) determines whether any active edges exist which are no longer required. If this is, in fact the case, then the process segment 800′ is directed in accordance with a “yes” arrow to a step 880 (see Appendix A lines 390 to 406) that removes such active edges. If, on the other hand, there are no such edges, then the process segment 800′ is directed in accordance with a “no” arrow, and thence via an arrow segment 842, back to the arrow segment 842 in FIG. 9 to the step 806 (see Appendix A line 173).

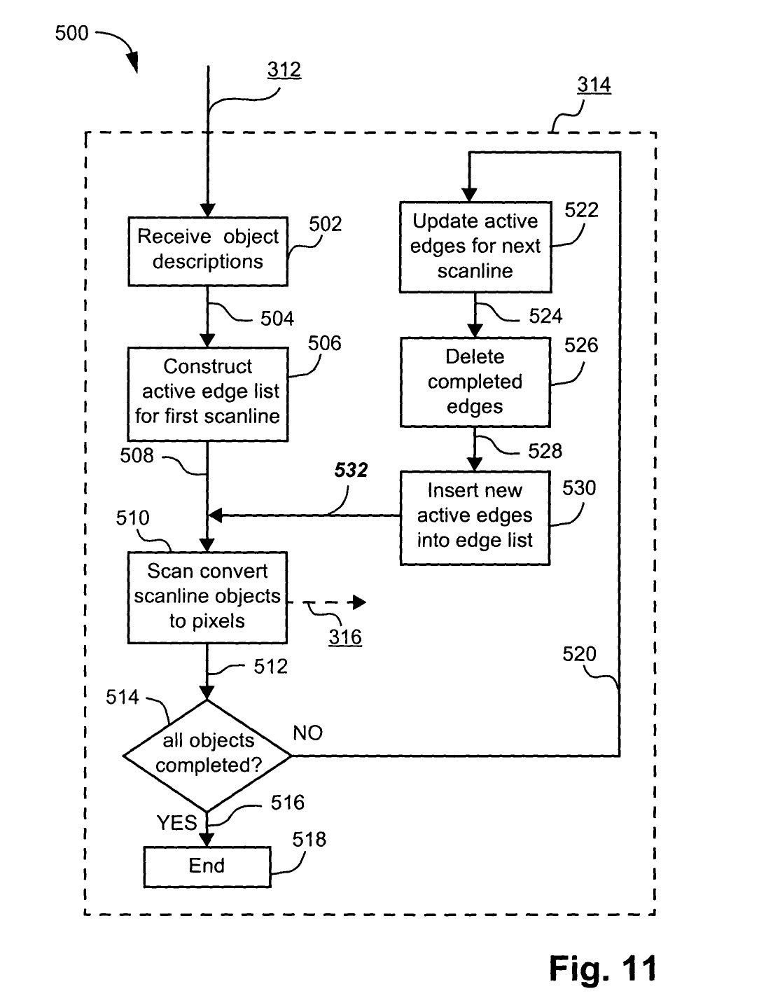

FIG. 11 shows a flow diagram 500 of the ERP process 314 that renders the ERP object representation received from the PCP to sequential pixels. The process 500 commences with a step 502 which receives the object descriptions from the PCP (these being the ERP output edge list records exemplified by [3]). A subsequent step 506 constructs an active edge list for the first scanline, after which a step 510 scan converts scanline objects to pixels. These pixel values are output, as depicted by a dashed arrow 316. A subsequent testing step 514 determines whether all objects on the scanline have been completed. If this is, in fact, the case then the process 500 is directed in accordance with a “yes” arrow to a termination step 518. If, on the other hand, not all objects have been completed, then the process 500 is directed in accordance with a “no” arrow to a step 522 which updates active edges for the next scanline. Thereafter, a step 526 deletes completed edges from the active edge list, and a subsequent step 530 inserts new active edges into the edge list. The process 500 is then directed in accordance with an arrow 532 to the step 510.

### INDUSTRIAL APPLICABILITY

It is apparent from the above that the arrangements described are applicable to the data processing industry.

The foregoing describes only one embodiment of the present invention, and modifications and/or changes can be made thereto without departing from the scope and spirit of the invention, the embodiments being illustrative and not restrictive. Thus for example, the described method could be extended to include transmission of graphic material for dynamic displays, e.g. object based animations across a network. Furthermore, although the description is couched in terms of objects having uniform opaque colours, the described method can be easily adapted to apply to objects having varying colours and opacity, provided that the ERP can deal with bit maps having colour and opacity described by linear ramps and/or linear transformations.

```
APPENDIX A
/*
*  Pseudo implementation of PCP edge to ERP edge algorithm
*  for simple non-compositing case. Must sort output ERP list
*/
#include <stdlib.h>
#include <memory.h>
typedef struct
{
  unsigned char r;
  unsigned char g;
  unsigned char b;
} rgb;
#define LEADING  1
#define LAGGING  0
/*
* pcp_edge - representation of a PCP input edge
* for the algorithm
*/
typedef struct pcp_edge
{
```

| struct pcp_edge *next; | |
|---|---|
| double | current_x; |
| double | x_increment; |
| int | starting_y; |
| int | ending_y; |
| int | level_number; |
| rgb | color; |
| int | leading:1; |

} pcp_edge;
/*
* erp_edge - representation of an ERP output edge
* for the algorithm
*/
typedef struct erp_edge
{

| struct erp_edge *next; | |
|---|---|
| int | starting_x; |
| int | starting_y; |
| double | current_x; |
| double | x_increment; |
| int | ending_y; |
| rgb | color; |

} erp_edge;
/*
* sort_pcp_edges_in_x
* Sort a list of pcp_edges into correct ‘x’ order,
* also sort for next scanline step.
*
* Arguments:
* pcp_list The list to sort
*
* Returns:
* The head of the sorted list
*/
static pcp_edge *
sort_pcp_edges_in_x
(

| | |
|---|---|
| pcp_edge | *pcp_list |
| ) | |
| { | |
| pcp_edge | *e; |

```
  /*
  * Bubble sort, which is OK, since most of the
  * time the list will be sorted.
  */
  for (;;) {
```

for
(

e = pcp_list;
e != NULL && e->next != NULL;
e = e->next) {
if
(

e->next->current_x < e->current_x
∥
(

e->next->current_x == e->current_x
&&
e->next->x_increment <e->x_increment

)

) {

pcp_edge t;
pcp_edge *np;
t = *e->next;
np = e->next;
*e->next = *e;
e->next->next = t.next;
*e = t;
e->next = np; /* fix the list pointer */
e = pcp_list; /* force reloop */
break;

}

}
if (e == NULL ∥ e->next == NULL)

break;

```
  }
  return pcp_list;
}
/*
* use a table to flag which levels are active
*/
#define MAX_LEVELS 32
pcp_edge  *level_is_active[MAX_LEVELS];
/*
* find_top_active_edge
*  Find the topmost active rendering object
*
* Returns the leading edge of the topmost object
*/
pcp_edge *
find_top_active_edge( )
{
  int  i;
  for
  (
  i = sizeof level_is_active / sizeof level_is_active[0] − 1;
  i > 0;
  i−−
  ) {
    if (level_is_active[i] != NULL)
    return level_is_active[i];
  }
  return NULL;
}
/*
* generate_erp_from_pcp
*  Convert and free a sorted list of “malloc'ed”
*  PCP edges to emit a linked list of ERP edges
*
* Arguments:
*  in - linked list of PCP edges, sorted in y,
*  then x then gradient order
* x_per_scanline - number of pixels in final
*  image ‘x’ dimension
* y_per_page - number of scanline in final
*  image ‘y’ dimension
*
* Returns:
*  A linked list of erp edges ready to encode
*  to send to an erp printer
*/
erp_edge *
generate_erp_from_pcp
(
  pcp_edge  *in,
```

| | |
|---|---|
| int | x_per_scanline, |
| int | y_per_page |

)
{

| | |
|---|---|
| pcp_edge | *active_pcp; |
| erp_edge | *out_list, **candidate_head; |

int current_y, current_x;

| | |
|---|---|
| pcp_edge | *p_pcp, *processed_pcp, *top_active; |
| erp_edge | *p_erp, *pe; |

```
  out_list = NULL;
  candidate_head = &out_list;
  active_pcp = NULL;
  current_y = 0;
  /*
  * construct active list
  */
build_active:
  if (current_y >= y_per_page)
    return out_list;
  while (in != NULL && in->starting_y <= current_y) {
    p_pcp = in;
    in = in->next;
    p_pcp->next = active_pcp;
    active_pcp = p_pcp;
  }
  /*
  * Clear the level activation table
  */
  memset(&level_is_active, 0, sizeof level_is_active);
  /*
  * Sort into sensible order
  */
  active_pcp = sort_pcp_edges_in_x(active_pcp);
  /*
  * scan through active list, compare with erp list,
  * and emit edges if necessary
  */
  for
  (
    p_pcp = processed_pcp = active_pcp,
      p_erp = *candidate_head;
        p_pcp != NULL && current_x < x_per_scanline;
        p_pcp = p_pcp->next
  ) {
        pcp_edge  *p, *top;
        int  toplevel, changed;
    current_x = (int)p_pcp->current_x;
      /*
      * Any erp edge that is before the next
    * active edge is finished
      */
      for
      ( ;
        p_erp != NULL
    &&
    (p_pcp == NULL ∥
      p_erp->current_x < p_pcp->current_x);
      p_erp = p_erp->next
    ) {
    if (p_erp->ending_y == 0)
          p_erp->ending_y = current_y;
  }
  /*
  * (de)activate levels for objects present
  * at this ‘x’ location
  */
  for
  (
    changed = 0, p = processed_pcp;
    p != NULL;
    p = p->next
  ) {
    if (p->current_x > current_x) /* finished */
      break;
    if (p->leading == LAGGING)
      level_is_active[p->level_number] = NULL;
    else
      level_is_active[p->level_number] = p;
    changed++; /* count crossings at current_x */
  }
  /*
  * Get the topmost active level before
  * we process this pcp edge
  */
  top_active = find_top_active_edge( );
  /*
  * If we crossed more than one edge,
  * terminate all erp edges here.
  */
  if (changed > 1) {
    for (p = processed_pcp; p != NULL; p = p->next) {
      if (p->current_x > current_x) /* finished */
        break;
      for (; p_erp != NULL; p_erp = p_erp->next)
        if (p_erp->current_x == current_x) {
          if (p_erp->ending_y == 0)
            p_erp->ending_y = current_y;
        }
        else
          goto done_terminating_erps;
    }
  }
done_terminating_erps:
    /*
    * find topmost edge at this x position and
  * check against erp list
    */
    top = NULL;
    toplevel = 0;
    for (p = processed_pcp; p != NULL; p = p->next) {
      if
    (
      p->current_x == current_x
      &&
      p->level_number > toplevel
    ) {
      if
      (
        top_active == NULL ∥
        p->level_number >=
          top_active->level_number) {
          top = p;
          toplevel = p->level_number;
        processed_pcp = top->next;
      }
    }
    }
    /*
    * We have an input pcp edge to check for
  * output erp edge
    */
    if (top != NULL) {
    /*
    * have highest pcp edge, if existing erp edge,
  * then fine, otherwise spawn
    */
    if (out_list == NULL) {
        p_erp = out_list = malloc(sizeof (erp_edge));
        p_erp->next = NULL;
        p_erp->starting_y = current_y;
        p_erp->starting_x = current_x;
    p_erp->current_x = (double)p_erp->starting_x;
        p_erp->x_increment = top->x_increment;
    p_erp->color = top->color;
    p_erp->ending_y = 0;
    candidate_head = &out_list;
    }
    /*
    * check for new edge creation
    */
    else if
    (
      p_erp == NULL
      ∥
      p_erp->current_x != top->current_x
      ∥
      p_erp->x_increment != top->x_increment
    ) {
        erp_edge  *h, *prev;
        h = malloc(sizeof (erp_edge));
    if (p_erp == NULL) {
    h->next = NULL;
          goto insert_x_sorted_into_out_list;
    }
    else {
      h->next = p_erp;
      if (*candidate_head == NULL) {
        h->next = NULL;
        *candidate_head = h;
      }
      if (*candidate_head == p_erp) {
        *candidate_head = h;
      }
      else {
insert_x_sorted_into_out_list:
          for
          (
            prev = *candidate_head == NULL ?
              out_list: *candidate_head;
            prev != NULL;
            prev = prev->next
          ) {
            if (prev->next == p_erp) {
              if (prev->next != NULL) {
                h->next = prev->next;
                prev->next = h;
            }
            else {
              prev->next = h;
            }
            break;
          }
        }
      }
    }
        h->starting_y = current_y;
        h->starting_x = current_x;
    h->current_x = (double)current_x;
        h->x_increment = top->x_increment;
    if
    (
      top->leading == LAGGING && top_active != NULL
      &&
      (
        top->current_x > top_active->current_x
        ∥
        (
          top->current_x ==
            top_active->current_x
          &&
          top->x_increment >
            top_active->x_increment
        )
      )
    )
      h->color = top_active->color;
    else
      h->color = top->color;
    h->ending_y = 0;
          p_erp = h;
  }
  p_erp = p_erp->next;
    }
}
/*
* Increment the current scanline
*/
current_y++;
/*
* Update the two edge lists and go to
  * incorporation of new edges
  */
  for (p_pcp = active_pcp; p_pcp != NULL;) {
      if (p_pcp->ending_y <= current_y) {
        pcp_edge  *chuck, *prev;
        chuck = p_pcp;
      p_pcp = p_pcp->next;
      if (active_pcp == chuck) {
        active_pcp = p_pcp;
      }
      else {
        for (prev = active_pcp; prev != NULL; prev = prev->next) {
          if (prev->next == chuck) {
            prev->next = p_pcp;
            break;
          }
        }
      }
      free(chuck);
      }
    else {
      p_pcp->current_x = p_pcp->current_x + p_pcp->x_increment;
      p_pcp = p_pcp->next;
    }
  }
  /*
  * If pcp active list is empty, all erp edges
  * must be terminated
  */
  if (active_pcp == NULL) {
      for (pe = out_list; pe != NULL; pe = pe->next) {
      if (pe->ending_y == 0)
          pe->ending_y = current_y;
      candidate_head = &pe->next;
    }
  }
  /*
  * similar for erp
  */
  for (pe = out_list; pe != NULL; pe = pe->next)
    pe->current_x = pe->current_x + pe->x_increment;
  goto build_active;
}
(End of Appendix A)
```

I claim:

1. A method of printing an image, the method comprising the steps of:
generating at a host, from an image to be printed, a display list representation of a visually equivalent image comprising non-overlapping graphic objects; and
scan-line rendering, using the display list representation, the visually equivalent image at a printer communicating with the host, without performing overlap detection at the printer.

2. A method of converting a representation of a first image, having a first set of overlapping graphic objects, into a display list representation of a visually equivalent second image, having a second set of non overlapping graphic objects, said method comprising the steps of:
(a) categorising each graphic object in the first set as being one of (i) a fully visible graphic object, (ii) a partly visible graphic object, and (iii) an invisible graphic object;
(b) defining, in relation to each said fully visible graphic object in said first set, a substantially identical graphic object in the second set; and
(c) defining, in relation to visible regions of each said partly visible graphic object in said first set, one or more graphic objects being visually equivalent to the partly visible graphic object, in the second set.

3. A method of converting a representation of a first image, having a first set of graphic objects spanning a plurality of layers, into a display list representation of a visually equivalent second image, having a second set of graphic objects on a single layer, said method comprising the steps of:
(a) categorising each graphic object in the first set as being one of (i) a fully visible graphic object, (ii) a partly visible graphic object, and (iii) an invisible graphic object;
(b) defining, in relation to each said fully visible graphic object in said first set, a substantially identical graphic object in the second set; and
(c) defining, in relation to visible regions of each said partly visible graphic object in said first set, one or more graphic objects being visually equivalent to the partly visible graphic object, in the second set.

4. A method of converting, on a scanline basis, a representation of a first image having a first set of overlapping graphic objects, into a display list representation of a visually equivalent second image having a second set of non overlapping graphic objects, said method comprising, for a current scanline, the steps of:
(a) determining, in a current scanning direction, a leading and a lagging edge of a visible region of a first one of said graphic objects in said first set;
(b) defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;
(c) defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:
(d) repeating steps (a) to (d) for all successive pairs of leading and lagging edges on the scanline; wherein said pairs of leading and lagging edges establish the second set of visually equivalent graphic objects for said current scanline.

5. A method of converting, on a scanline basis, a representation of a first image having a first set of graphic objects spanning a plurality of layers, into a display list representation of a visually equivalent second image having a second set of graphic objects on a single layer, said method comprising, for a current scanline, the steps of:
(a) determining, in a current scanning direction, a leading and a lagging edge of a visible region of a first one of said graphic objects in said first set;
(b) defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;
(c) defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:
(d) repeating steps (a) to (d) for all successive pairs of leading and lagging edges on the scanline; wherein said pairs of leading and lagging edges establish the second set of visually equivalent graphic objects for said current scanline.

6. A method according to claim 2, wherein at least one of the first set of overlapping graphic objects and the second set of non overlapping graphic objects are opaque.

7. An apparatus for printing an image, the apparatus comprising:
means for generating at a host, from an image to be printed, a display list representation of a visually equivalent image comprising non-overlapping graphic objects; and
means for scan-line rendering, using the display list representation, the visually equivalent image at a printer communicating with the host, without performing overlap detection at the printer.

8. An apparatus for converting a representation of a first image, having a first set of overlapping graphic objects, into a display list representation of a visually equivalent second image, having a second set of non overlapping graphic objects, said apparatus comprising:
(a) means for categorising each graphic object in the first set as being one of (i) a fully visible graphic object, (ii) a partly visible graphic object, and (iii) an invisible graphic object;
(b) means for defining, in relation to each said fully visible graphic object in said first set, a substantially identical graphic object in the second set; and
(c) means for defining, in relation to visible regions of each said partly visible graphic object in said first set, one or more graphic objects being visually equivalent to the partly visible graphic object, in the second set.

9. An apparatus for converting a representation of a first image, having a first set of graphic objects spanning a plurality of layers, into a display list representation of a visually equivalent second image, having a second set of graphic objects on a single layer, said apparatus comprising:
(a) means for categorising each graphic object in the first set as being one of (i) a fully visible graphic object, (ii) a partly visible graphic object, and (iii) an invisible graphic object;
(b) means for defining, in relation to each said fully visible graphic object in said first set, a substantially identical graphic object in the second set; and
(c) means for defining, in relation to visible regions of each said partly visible graphic object in said first set, one or more graphic objects being visually equivalent to the partly visible graphic object, in the second set.

10. An apparatus for converting, on a scanline basis, a representation of a first image having a first set of overlapping graphic objects, into a display list representation of a visually equivalent second image having a second set of non overlapping graphic objects, said apparatus comprising:
(a) means for determining, in a current scanning direction, a leading and a lagging edge of a visible region of a first one of said graphic objects in said first set;
(b) means for defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;
(c) means for defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:
(d) means for repeating steps (a) to (d) for all successive pairs of leading and lagging edges on the scanline; wherein said pairs of leading and lagging edges establish the second set of visually equivalent graphic objects for said current scanline.

11. An apparatus for converting, on a scanline basis, a representation of a first image having a first set of graphic objects spanning a plurality of layers, into a display list representation of a visually equivalent second image having a second set of graphic objects on a single layer, said apparatus comprising:
(a) means for determining, in a current scanning direction, a leading and a lagging edge of a visible region of a first one of said graphic objects in said first set;
(b) means for defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;
(c) means for defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:
(d) means for repeating steps (a) to (d) for all successive pairs of leading and lagging edges on the scanline; wherein said pairs of leading and lagging edges establish the second set of visually equivalent graphic objects for said current scanline.

12. A computer program for directing a processor to execute a method of converting a representation of a first image, having a first set of overlapping graphic objects, into a display list representation of a visually equivalent second image, having a second set of non overlapping graphic objects, said program comprising:
(a) code for categorising each graphic object in the first set as being one of (i) a fully visible graphic object, (ii) a partly visible graphic object, and (iii) an invisible graphic object;
(b) code for defining, in relation to each said fully visible graphic object in said first set, a substantially identical graphic object in the second set; and
(c) code for defining, in relation to visible regions of each said partly visible graphic object in said first set, one or more graphic objects being visually equivalent to the partly visible graphic object, in the second set.

13. A computer program for directing a processor to execute a method of converting a representation of a first image, having a first set of graphic objects spanning a plurality of layers, into a display list representation of a visually equivalent second image, having a second set of graphic objects on a single layer, said program comprising:
(a) code for categorising each graphic object in the first set as being one of (i) a fully visible graphic object, (ii) a partly visible graphic object, and (iii) an invisible graphic object;
(b) code for defining, in relation to each said fully visible graphic object in said first set, a substantially identical graphic object in the second set; and
(c) code for defining, in relation to visible regions of each said partly visible graphic object in said first set, one or more graphic objects being visually equivalent to the partly visible graphic object, in the second set.

14. A computer program for directing a processor to execute a method of converting, on a scanline basis, a representation of a first image having a first set of overlapping graphic objects, into a display list representation of a visually equivalent second image having a second set of non overlapping graphic objects, said program comprising, in relation to a current scanline:
(a) code for determining, in a current scanning direction, a leading and a lagging edge of a visible region of a first one of said graphic objects in said first set;
(b) code for defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;
(c) code for defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:
(d) code for repeating steps (a) to (d) for all successive pairs of leading and lagging edges on the scanline; wherein said pairs of leading and lagging edges establish the second set of visually equivalent graphic objects for said current scanline.

15. A computer program for directing a processor to execute a method of converting, on a scanline basis, a representation of a first image having a first set of graphic objects spanning a plurality of layers, into a display list representation of a visually equivalent second image having a second set of graphic objects on a single layer, said program comprising, in relation to a current scanline:
(a) code for determining, in a current scanning direction, a leading and a lagging edge of a visible region of a first one of said graphic objects in said first set;
(b) code for defining said lagging edge to be a leading edge of a next one of said graphic objects if (i) said first graphic object extends beyond said lagging edge in the current scanning direction and (ii) said next graphic object is visible immediately beyond the lagging edge in said current scanning direction;
(c) code for defining said lagging edge to be a leading edge of a next one of said graphic objects if (i) said next graphic object extends beyond said lagging edge in a direction opposite to the current scanning direction, and (ii) said next graphic object is visible immediately beyond the lagging edge in said current scanning direction; and:
(d) code for repeating steps (a) to (d) for all successive pairs of leading and lagging edges on the scanline; wherein said pairs of leading and lagging edges establish the second set of visually equivalent graphic objects for said current scanline.
